(19) United States
(12) Patent Application Publication
(10) Pub. No.: US 2026/0021981 A1
(43) Pub. Date: Jan. 22, 2026

(54) RAMP COMPONENT SYSTEM

(71) Applicant: Owen Woodruff Bunker, II, Denver, CO (US)

(72) Inventor: Owen Woodruff Bunker, II, Denver, CO (US)

(21) Appl. No.: 19/229,711

(22) Filed: Jun. 5, 2025

Related U.S. Application Data
(63) Continuation of application No. 17/939,342, filed on Sep. 7, 2022, now Pat. No. 12,344,490.
Application No. 17/939,342 is a continuation of application No. 16/549,796, filed on Aug. 23, 2019, now Pat. No. 11,440,754.
Application No. 16/549,796 is a continuation of application No. 14/153,787, filed on Jan. 13, 2014, now abandoned.
(60) Provisional application No. 61/751,362, filed on Jan. 11, 2013.

(51) Int. Cl. B65G 69/30; E01D 15/12; E04F 11/00; F16B 45/00

(52) U.S. Cl. CPC B65G 69/30; E04F 11/002; F16B 45/00; E01D 15/12; E04F 2011/005; E04F 2011/007

(57) ABSTRACT

A ramp system is disclosed which may include first and second components. The first component may include horizontal and vertical portions, and a hook. The horizontal portion may be supported by a lip of a structure, and may have a width equivalent to a length of the lip. The vertical portion may be coupled with, and hang downward from, the horizontal portion, and may have the same width as the horizontal portion. The hook may be coupled with the vertical portion, and may have the same width as the horizontal portion. The second component may include a protrusion and channel. The protrusion may have a width equal or less than the width of the horizontal portion, and be supported by the hook. The channel may be coupled with the protrusion, and have the same width. The channel may receive a planar component which forms a sloped surface of a ramp.

### CROSS-REFERENCE TO RELATED APPLICATIONS

This application is continuation application of U.S. patent application Ser. No. 17/939,342 by BUNKER II, entitled “RAMP COMPONENT SYSTEM,” filed Sep. 7, 2022, which is a continuation of U.S. patent application Ser. No. 16/549,796 by BUNKER II, entitled “RAMP COMPONENT SYSTEM,” filed Aug. 23, 2019; now U.S. Pat. No. 11,440,754, issued Sep. 13, 2022, which is a continuation of U.S. patent application Ser. No. 14/153,787 by BUNKER II, entitled “RAMP COMPONENT SYSTEM,” filed Jan. 31, 2014, which claims priority to Provisional U.S. Patent Application No. 61/751,362 by BUNKER II, entitled “RAMP COMPONENT SYSTEM,” filed Jan. 11, 2013. The entire disclosure of the aforementioned U.S. Patent Applications are hereby incorporated by reference, for all purposes, as if fully set forth herein.

### BACKGROUND OF THE INVENTION

This invention relates generally to ramp systems. More specifically the invention relates to modular ramp systems for accessing buildings, storage containers, vehicles, and/or other structures.

### BRIEF DESCRIPTION OF THE INVENTION

In one embodiment, a ramp system is provided. The ramp system may include a first component and a second component. The first component may include a horizontal portion, a vertical portion, and a first hook. The horizontal portion may be configured to be supported by a top portion of a lip of a structure, where the horizontal portion may have a width equivalent to a length of the lip which supports the horizontal portion. The vertical portion may be coupled with an edge of the horizontal portion and configured to hang downward from the horizontal portion along a side portion of the lip of the structure, where the vertical portion may have the same width as the horizontal portion. The first hook may be coupled with the vertical portion, where the first hook may have the same width as the horizontal portion. The second component may include a first protrusion and a first channel. The first protrusion may have a maximum width equal to or less than the width of the horizontal portion, where the first protrusion may be configured to be supported by the first hook. The first channel may be coupled with the first protrusion, where the first channel may have the same width as the first protrusion. The first channel may be configured to receive a first planar component which forms a sloped surface of a first ramp.

In another embodiment, a kit for providing a ramp is provided. The kit may include a first component and a second component. The first component may include a horizontal portion, a vertical portion, and a first hook. The horizontal portion may be configured to be supported by a top portion of a lip of a structure, where the horizontal portion may have a width equivalent to a length of the lip which supports the horizontal portion. The vertical portion may be coupled with an edge of the horizontal portion and configured to hang downward from the horizontal portion along a side portion of the lip of the structure, where the vertical portion may have the same width as the horizontal portion. The first hook may be coupled with the vertical portion, where the first hook may have the same width as the horizontal portion. The second component may include a first protrusion and a first channel. The first protrusion may have a maximum width equal to or less than the width of the horizontal portion, where the first protrusion may be configured to be supported by the first hook. The first channel may be coupled with the first protrusion, where the first channel may have the same width as the first protrusion. The first channel may be configured to receive a first planar component which forms a sloped surface of a first ramp.

In another embodiment, a method for providing a ramp to a lip of a structure is provided. The method may include coupling a first component to the lip of the structure. The first component may include a horizontal portion, a vertical portion, and a first hook. The horizontal portion may be configured to be supported by a top portion of a lip of a structure, where the horizontal portion may have a width equivalent to a length of the lip which supports the horizontal portion. The vertical portion may be coupled with an edge of the horizontal portion and configured to hang downward from the horizontal portion along a side portion of the lip of the structure, where the vertical portion may have the same width as the horizontal portion. The first hook may be coupled with the vertical portion, where the first hook may have the same width as the horizontal portion. The method may also include coupling a first planar component with a second component. The second component may include a first protrusion and a first channel. The first protrusion may have a maximum width equal to or less than the width of the horizontal portion, where the first protrusion may be configured to be supported by the first hook. The first channel may be coupled with the first protrusion, where the first channel may have the same width as the first protrusion. The first channel may be configured to receive a first planar component which forms a sloped surface of a first ramp. The method may further include depositing the first protrusion into the first hook.

### BRIEF DESCRIPTION OF THE DRAWINGS

The present invention is described in conjunction with the appended figures:

FIG. 1 is a side view of a ramp system embodiment of the invention;

FIG. 2 is a side view of the ramp system of FIG. 1 in a different configuration;

FIG. 3A is a side view of another ramp system embodiment of the invention;

FIG. 3B is a side view of another ramp system embodiment of the invention;

FIGS. 4A-4D are side views of various first components as present in varying embodiments of the invention;

FIGS. 5A-5C are cross sections of various second components as present in varying embodiments of the invention;

FIGS. 6A-6B are cross sections of potential hooked portions of the protrusions of second components present in some embodiments of the invention;

FIG. 7 is a side view of an embodiment of the invention as attached to a structure for providing access thereto;

FIG. 8A is a perspective view of an embodiment of the invention where a single ramp is present; and

FIG. 8B is a perspective view of an embodiment of the invention where two ramps are present.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims. For example, any detail in one embodiment may not be included in other versions of that embodiment, or may be added to any other embodiment or modified version of the other embodiment.

Specific details are given in the following description to provide a thorough understanding of the embodiments. However, it will be understood by one of ordinary skill in the art that the embodiments may be practiced without these specific details. For example, systems, processes, and other elements in the invention may be shown as components in block diagram form in order not to obscure the embodiments in unnecessary detail. In other instances, well-known processes, structures, and techniques may be shown without unnecessary detail in order to avoid obscuring the embodiments.

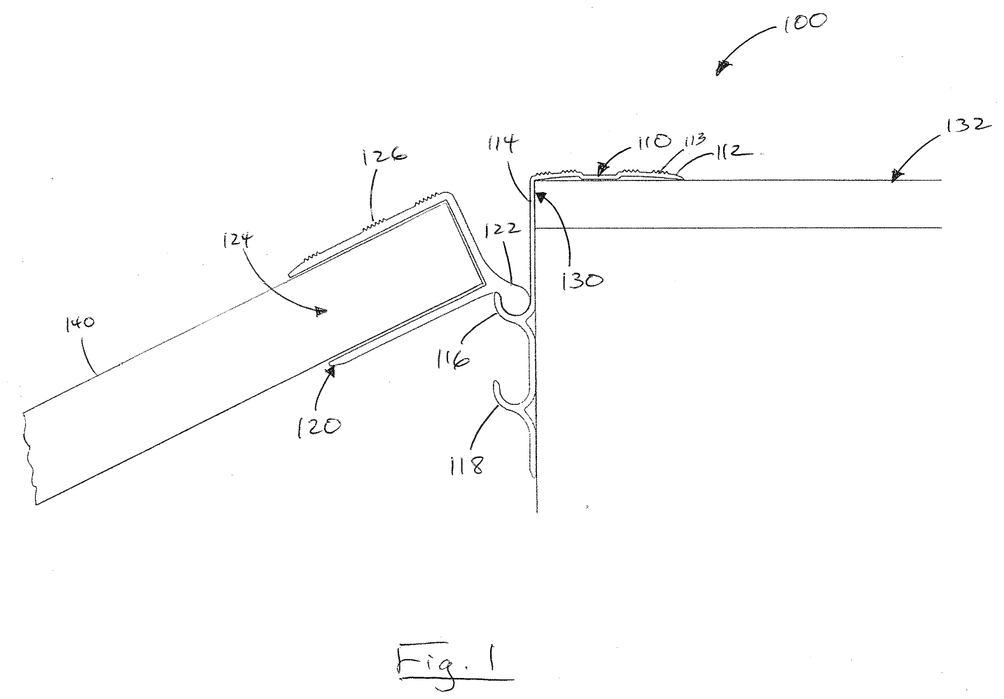

Embodiments discussed herein allow for a ramp or ramps to be affixed to a shed, storage container, building, vehicle (i.e., truck beds, trailers, recreational vehicles, etc.), towable storage, or other device/structure (hereinafter, collectively, “structure”). Systems, kits, and methods are provided by various embodiments of the invention that will become apparent to those of skill in the art after reading the present disclosure. Turning now to FIG. 1, a ramp system 100 embodiment is shown. The ramp system may include a first component 110 and a second component 120.

First component 110 may include a horizontal portion 112, a vertical portion 114, and a first hook 116. Horizontal portion 112 may be configured to be supported by a top portion of a lip 130 of a structure 132. Horizontal portion 112 may have a width equivalent to a length of lip 130 which supports horizontal portion 112 (i.e., approximately the width of the doorway or less). In some embodiments, horizontal portion 112 may include anti-slip features 113. In some embodiments horizontal portion 112 may consist of, or constitute, sill nosing. First component 110 may couple with lip 130 in any number of possible ways, including fasteners (i.e., screws, nails, etc.), adhesives (i.e., glue), and/or ribs which bite into lip 130. Such coupling mechanisms may be employed anywhere along the interface of first component 110 with lip 130.

Vertical portion 114 may be coupled with an edge of horizontal portion 112 and may be configured to hang downward from horizontal portion 112 along a side portion of lip 130 of structure 132. Vertical portion 114 may have the same width as horizontal portion. 112 (i.e., approximately the width of the doorway or less). First hook 116 may be coupled with vertical portion 114, and may have the same width as the horizontal portion 112 (i.e., approximately the width of the doorway or less). In some embodiments, first hook 116 may have a width less than that of the horizontal portion 112.

Second component 120 may include a first protrusion 122 and a first channel 124. First protrusion 122 may have a maximum width equal to or less than the width of the horizontal portion 112 (i.e., approximately the width of the doorway or less). First protrusion 122 may be configured to be supported by first hook 116. This allows for the ramp, depending on the length of the ramp, the range of motion permitted by the knuckle/hook, as well as surrounding terrain, to extend away from the structure at variable angle. This can allow for the ramp angle to vary as the building and ramp settle into the supporting surface (i.e. the ground) at a different rate.

First channel 124 may be coupled with first protrusion 122, where first channel 124 may have the same width as first protrusion 122 (i.e., equal to or less than the width of the horizontal portion 112 (i.e., approximately the width of the doorway or less)). First channel 124 may be configured to receive a first planar component 140 which forms a sloped surface of a first ramp. In some embodiments, the top exterior of first channel 124 may include anti-slip features 126. Second component 120 may couple with lip first planar component 140 in any number of possible ways, including fasteners (i.e., screws, nails, etc.), adhesives (i.e., glue), and/or ribs which bite into first planar component 140. Such coupling mechanisms may be employed anywhere along the interface of second component 120 with first planar component 140.

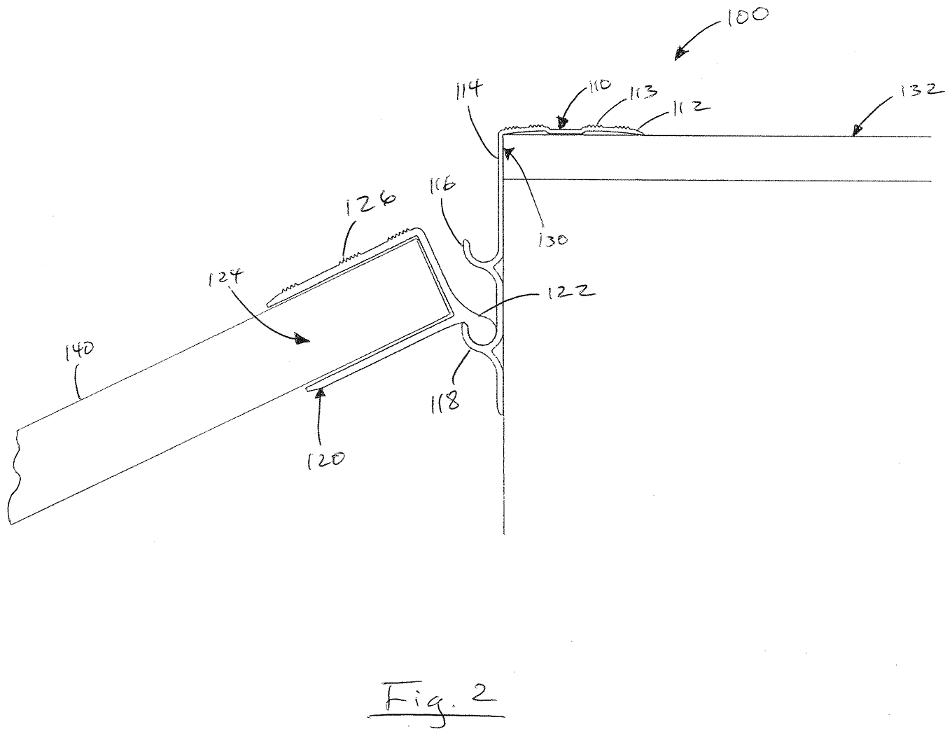

In some embodiments, a second hook 118 maybe coupled with vertical portion 114, wherein second hook 118 may have the same width as horizontal portion 110, and is also configured to support first protrusion 122. FIG. 2 shows second hook 118 supporting first protrusion 122. In some embodiments, second hook 118 may have a width less than that of the horizontal portion 112.

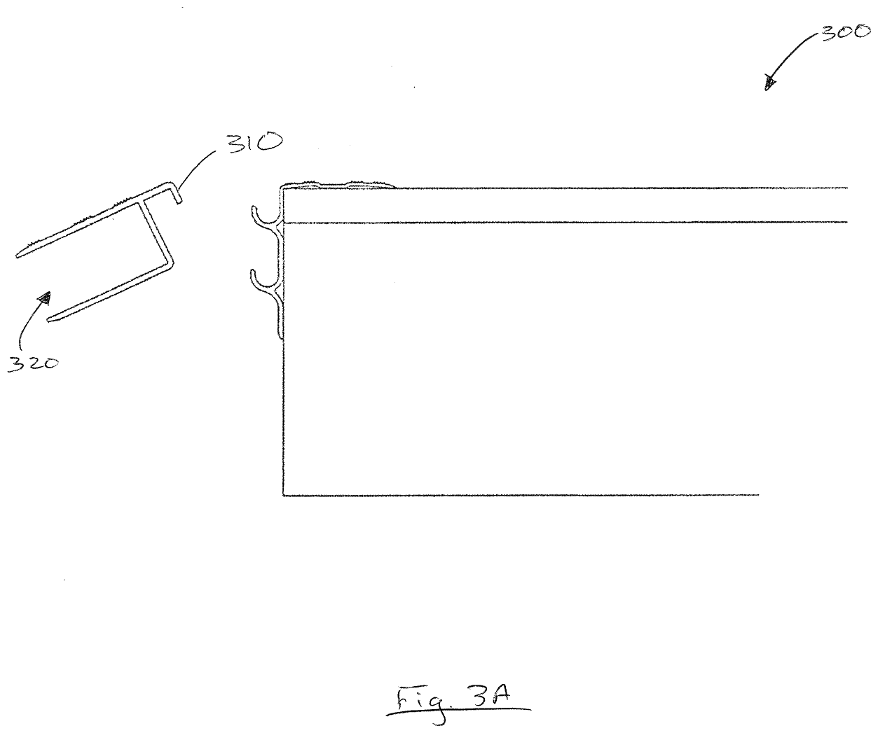

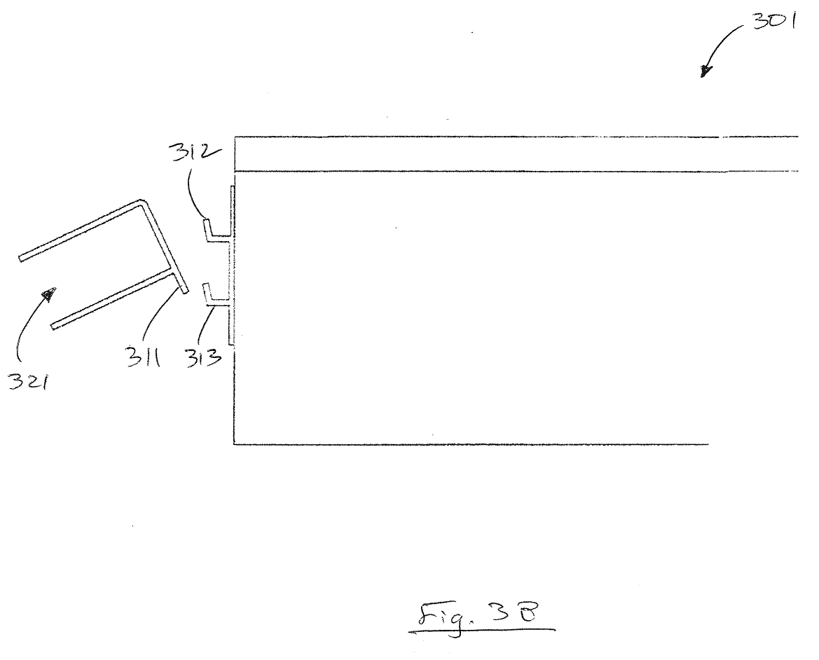

While in FIGS. 1 and 2 hooks 116, 118 are shown as being round, and first protrusion 122 is also round and at least partially congruent with hooks 116, 118, other shapes for hooks 116, 188 and first protrusion 122 are also possible. FIG. 3A and FIG. 3B show other potential configurations. System 300 shows an angled protrusion 310, while system 301 shows a straight protrusion 311 and angled hooks 312, 313. Also note that (a) protrusion 310 is located at the opposite corner of channel 320 than channels 124, 321, and that (b) the first component may not have a horizontal portion, instead coupling directly to the side of the lip, as shown in FIG. 3B. In these or other embodiments, the second component may also not include a channel, but instead couple to one side or edge of the planar component. For example, the second component may couple to the bottom of the planar component, the end/edge of the planar component, and/or the top of planar component. These variations may be possible in any embodiment discussed herein.

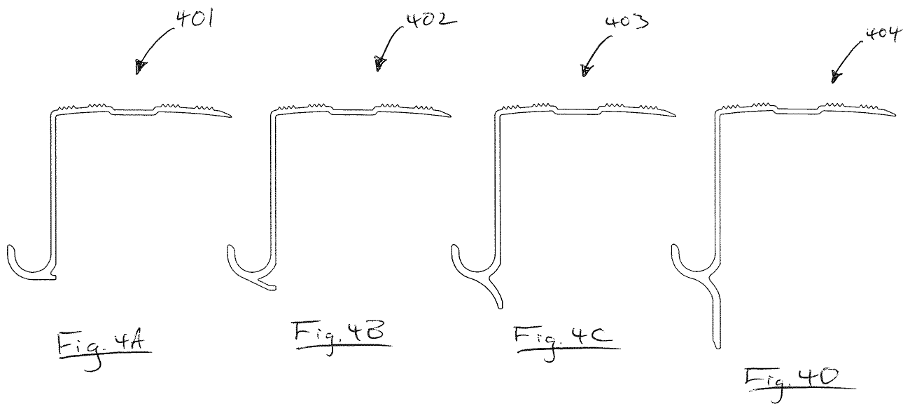

FIGS. 4A-4D show variations 401, 402, 403, 404 of first component 110 which include only a first hook 116, and not a second hook 118. In yet other embodiments, a first component may have three or more hooks to allow the ramp to be provided at a number of possible elevations.

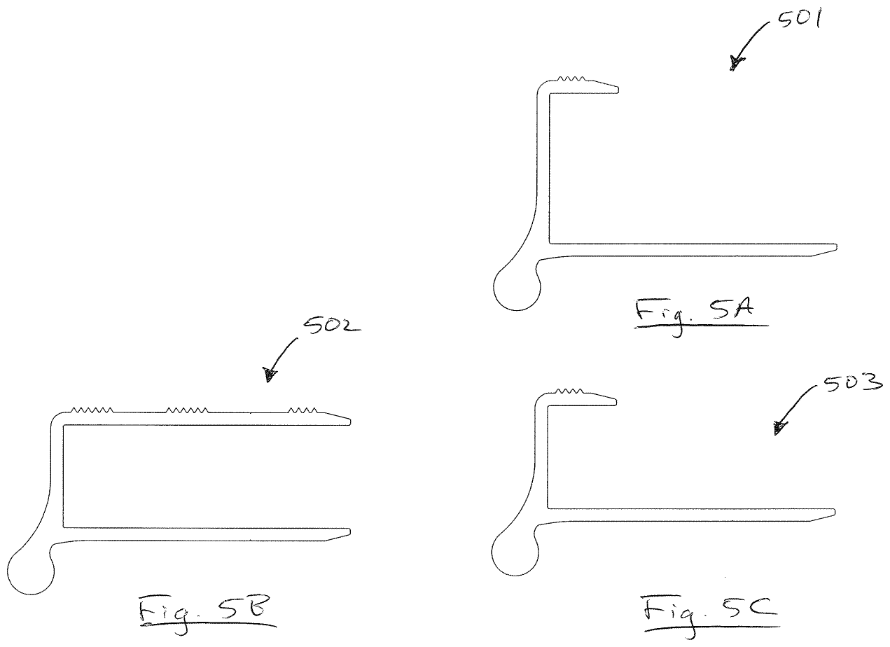

FIGS. 5A-5C show variations 501, 502, 503 of second component 120 which have differing channel widths (501 versus 503), and/or different lengths of channel walls (501, 503 versus 502).

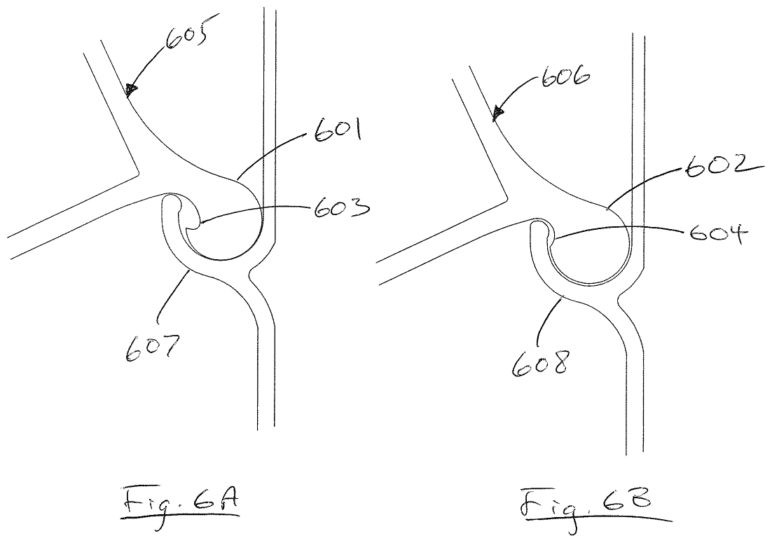

FIGS. 6A-6B show protrusions 601, 602 which have a hooked portion 603, 604 which assist in resisting movement of second component 605, 606 from hook 607, 608. This detail may be present in various embodiments of the invention to assist in preventing accidental or unintentional removal of the ramp from the structure. If second component 605, 606 is rotated too far downward, or pulled away from hook 607, 608, hooked portion 603, 604 may engage the tip of hook 607, 608, thereby discouraging disengagement of the ramp. Hooks 607, 608 may also have bulbous ends, as shown, to at least partially assist in preventing removal of the ramp from the structure.

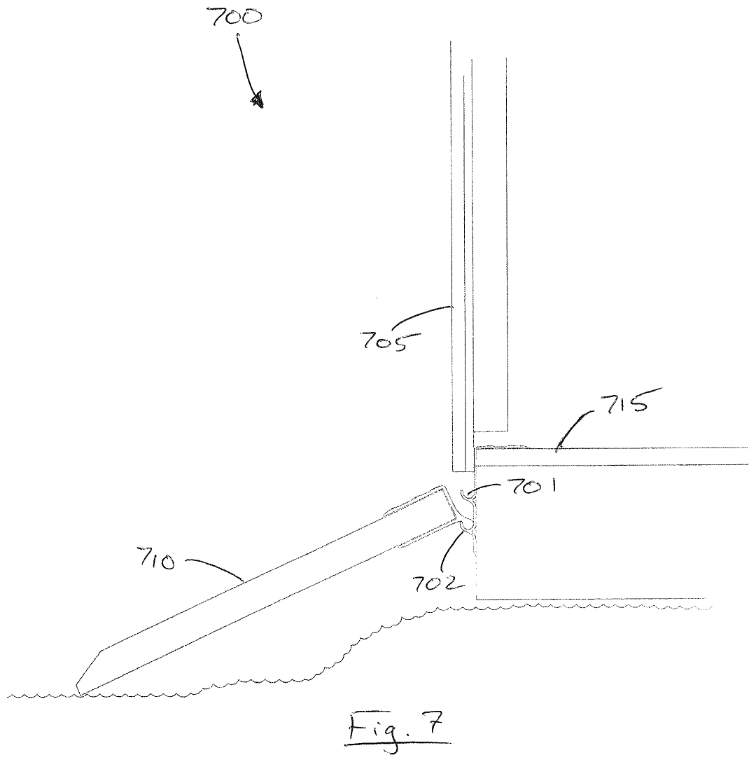

FIG. 7 shows one example 700 of why multiple hooks 701, 702 may be present in some embodiments. When door 705 is closed, having ramp 710 engaged in hook 701 may not be possible because of the overhang of door 705. When door 705 is to be opened or closed, ramp 710 may therefore be engaged in hook 702. While door 705 is open, and access to the structure desired, ramp 710 may be engaged in hook 701 to bring the top of ramp 710 in closer proximity to the level of floor 715. Thus, hook 701 provides for easy access to the structure, while hook 702 provides for storage of the ramp in the meantime, as well as ramped access when height of the ramp compared to the level of floor 715 is not critical (i.e., when a dolly or other loading device is not being employed).

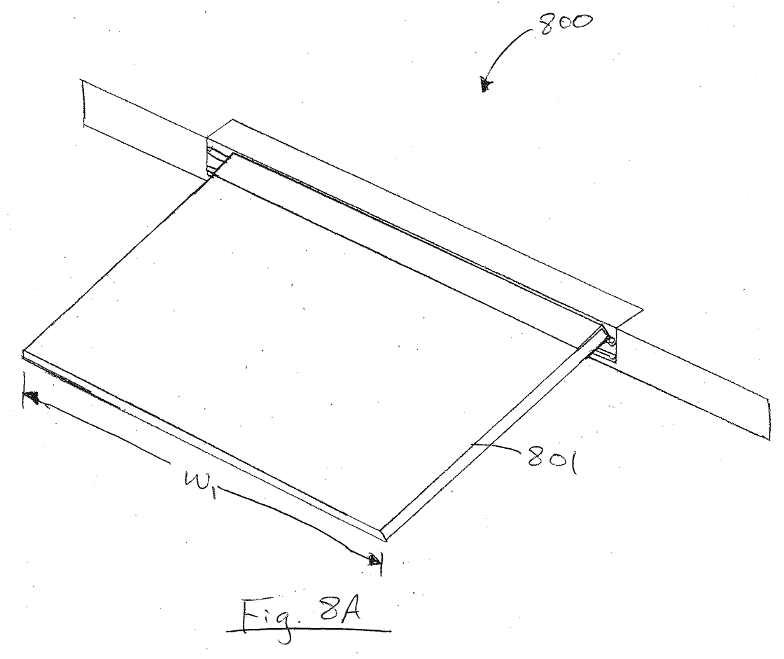

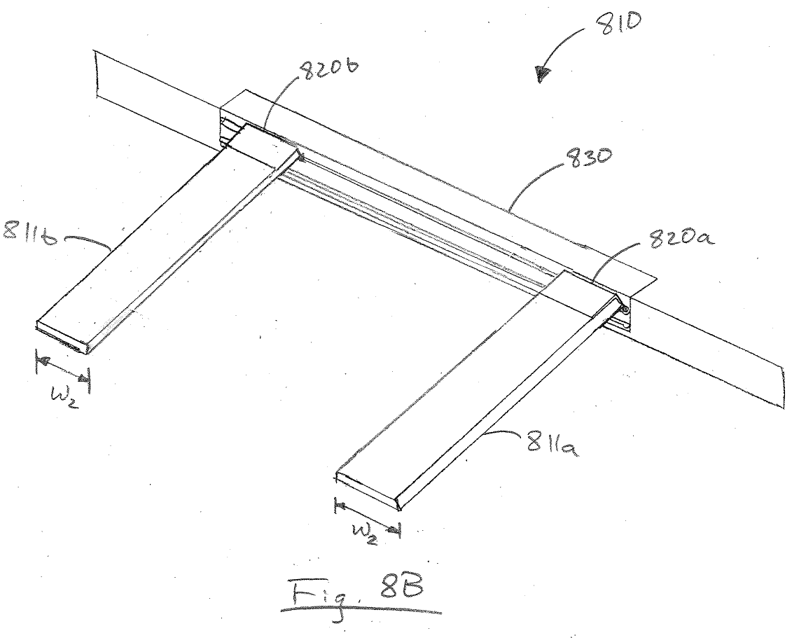

FIG. 8A shows one embodiment 800 where a single ramp 801 is employed. In this embodiment, single ramp 801 provides access to the structure. The width (‘W₁’) of single ramp 801 may be approximately equal to or less than the width of a corresponding door or other egress from the structure. FIG. 8B shows an alternative embodiment 810 where two ramps 811 are employed. In this embodiment, the width (‘W₂’) of each ramp 811 may be less than the width of a corresponding door or other egress from the structure. Additionally, two second components 820 may be necessary in this embodiment (one for each ramp 811), but only one first component 830 may be used. In other embodiments, multiple separate smaller first components 830 may be used, one at each ramp connection. Embodiments similar to 810 may allow a means of providing vehicle ramps, where wheels may roll up-and-down ramps 811.

The invention has now been described in detail for the purposes of clarity and understanding. However, it will be appreciated that certain changes and modifications may be practiced within the scope of the appended claims.

1. (canceled)

2. A method of installing a ramp on a shed, comprising:
engaging a downward-facing protrusion of a top end of a ramp into a channel of an upward-facing hook feature that is positioned below an entry opening of a shed, wherein:
the upward-facing hook feature comprises a vertical member that is coupled with a substantially vertical surface of the shed beneath the entry opening; and
the downward-facing protrusion is sized and shaped to permit relative rotation between the downward-facing protrusion and the upward-facing hook feature while the downward-facing protrusion is engaged with the upward-facing hook feature; and
positioning a lower end of the ramp into contact with a ground surface that is spaced apart from the entry opening of the shed.

3. The method of installing a ramp on a shed of claim 2, further comprising:
securing the upward-facing hook feature to the shed.

4. The method of installing a ramp on a shed of claim 3, wherein:
securing the upward-facing hook feature to the shed comprises attaching a horizontal member coupled with the upward-facing hook feature to an upward-facing surface of the entry opening.

5. The method of installing a ramp on a shed of claim 3, wherein:
securing the upward-facing hook feature to the shed comprises using at least one of a fasteners, an adhesive, or a rib that bites into a surface of the entry opening.

6. The method of installing a ramp on a shed of claim 2, wherein:
positioning the lower end of the ramp into contact with the ground surface comprises pivoting the ramp downward to vary an angle of the ramp with respect to the shed until the lower end of the ramp contacts the ground surface.

7. The method of installing a ramp on a shed of claim 2, wherein:
the upward-facing hook feature comprises a distal end that is laterally spaced apart from the vertical member; and
an upper end of the distal end terminates below a lower horizontal surface of the entry opening.

8. The method of installing a ramp on a shed of claim 2, wherein:
the upward-facing hook feature comprises one of a plurality of upward-facing hook features positioned below an entry opening of a shed; and
each of the plurality of upward-facing hook features is disposed at a different vertical position relative to the entry opening.

9. A method of installing a ramp on a shed, comprising:
engaging a downward-facing protrusion of a top end of a ramp into a channel of an upward-facing hook feature that is positioned below an entry opening of a shed, wherein:
the upward-facing hook feature comprises a vertical member that is coupled with a substantially vertical surface of the shed beneath the entry opening; and
the downward-facing protrusion is sized and shaped to permit relative rotation between the downward-facing protrusion and the upward-facing hook feature while the downward-facing protrusion is engaged with the upward-facing hook feature; and
pivoting a lower end of the ramp downward into contact with a ground surface that is spaced apart from the entry opening of the shed while the downward-facing protrusion is engaged with the upward-facing hook feature.

10. The method of installing a ramp on a shed of claim 9, wherein:
the vertical member is coupled with a horizontal member such that the vertical member extends downward from the horizontal member at a substantially orthogonal angle; and
the horizontal member is positioned atop an upward-facing surface of the entry opening.

11. The method of installing a ramp on a shed of claim 10, wherein:
a vertical distance from a top of the upward-facing hook feature and a top surface of the horizontal member is greater than an opening width of the upward-facing hook feature; and
the horizontal member terminates at a junction with the vertical member such that the upward-facing hook feature extends laterally beyond distal end of the horizontal member and such that an open top of the channel remains uncovered by the horizontal member.

12. The method of installing a ramp on a shed of claim 9, wherein:
the downward-facing protrusion comprises at least one of an angled protrusion, a straight protrusion, a bulbous protrusion, a round protrusion, or an angled hook.

13. The method of installing a ramp on a shed of claim 9, wherein:
the ramp comprises a plurality of planar members.

14. The method of installing a ramp on a shed of claim 9, wherein:
the upward-facing hook feature extends along an entire width of the entry opening.

15. The method of installing a ramp on a shed of claim 9, wherein:
the downward-facing protrusion is sized and shaped to permit the ramp to extend away from the shed at a variable angle.

16. A method of installing a ramp on a structure, comprising:
engaging a downward-facing protrusion of a top end of a ramp into a channel of an upward-facing hook feature that is positioned below an entry opening of a structure, wherein:
the upward-facing hook feature comprises a vertical member that is coupled with a substantially vertical surface of the structure beneath the entry opening; and
the downward-facing protrusion is sized and shaped to permit relative rotation between the downward-facing protrusion and the upward-facing hook feature while the downward-facing protrusion is engaged with the upward-facing hook feature; and
positioning a lower end of the ramp into contact with ground surface that is spaced apart from the entry opening of the structure.

17. The method of installing a ramp on a structure of claim 16, wherein:
the upward-facing hook feature comprises an arcuate bottom surface.

18. The method of installing a ramp on a shed of claim 16, wherein:
the upward-facing hook feature comprises a planar bottom surface.

19. The method of installing a ramp on a shed of claim 16, wherein:
the vertical member terminates below an upper-facing surface of the entry opening.

20. The method of installing a ramp on a shed of claim 16, wherein:
an upper end of the vertical member forms an uppermost portion of the upward-facing hook feature.

21. The method of installing a ramp on a shed of claim 16, wherein:
the upward-facing hook feature forms a portion of a sill nosing of the entry opening.
